(19) United States
(12) Patent Application Publication
(10) Pub. No.: US 2007/0165964 A1
(43) Pub. Date: Jul. 19, 2007

(54) De-emphasis of user-selected portions in a video display

(76) Inventors: Carol Wolf, Redmond, WA (US); Hansen Wat, Redwood Shores, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,228

(22) Filed: Oct. 31, 2005

(51) Int. Cl. G06K 9/36

(52) U.S. Cl. 382/276

(57) ABSTRACT

A machine (e.g., a computer) is used to generate a video display for a display device. A user interactively causes the machine to apply a de-emphasis effect to user-selected portions of the video display. The de-emphasis effect may be used to reduce visual distraction caused by those portions.

### BACKGROUND

When a person's eyes focus on an object, the object is seen with relative clarity and sharpness. However, other objects at different distances from the person are seen out-of-focus (blurred). This “automatic blurring” effect of the human visual system has certain benefits. For instance, the blurred objects are less visually demanding, and therefore less apt to distract a person who is concentrating on the object that is in focus. This effect increases the ability to concentrate effectively while still maintaining sufficient peripheral awareness and ability to recognize whether concentration should be shifted to any of the blurred objects.

Unfortunately, this effect of the human vision system does not work with objects shown on a computer monitor or other electronic display device because the objects are all at the same distance from the person viewing the objects. Concentrating on one of the objects is harder because the other objects are also in focus. Thus, a greater effort is needed to concentrate attention on the one object, while blocking out the other objects. This, in turn, contributes to fatigue, eye strain and headaches.

It is not uncommon for a display of a computer desktop to be cluttered with many different elements, such as icons, thumbnails, multiple open application windows, and dialog boxes. Concentrating on one element among many, or repeatedly moving back and forth between several elements among many, can contribute to fatigue, eye strain and headaches.

The problem will grow worse in the near future. As display devices become larger and computers become faster and more powerful to handle multiple applications at once, the larger display devices will show an even greater number of windows. Additionally, a growing number of applications will launch or have windows pop up in response to outside events. This will make it increasingly challenging to concentrate, block out screen distractions, and filter out interruptions. Otherwise, if not effectively blocked out, the screen distractions and interruptions will increase the likelihood of errors. The problem will become compounded as the displays are spread out over two or more display devices.

It would be desirable to reduce the fatigue, eye strain and headaches caused by computer display devices and other electronic display devices. It would also be desirable to reduce the likelihood of errors due to distractions.

### SUMMARY

According to one aspect of the present invention, a machine is used to view a video display on a display device. A user interactively causes the machine to apply a de-emphasis effect to visually de-emphasize user-selected portions of the video display.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a method in accordance with an embodiment of the present invention.

FIG. 2 is an illustration of a system in accordance with an embodiment of the present invention.

### DETAILED DESCRIPTION

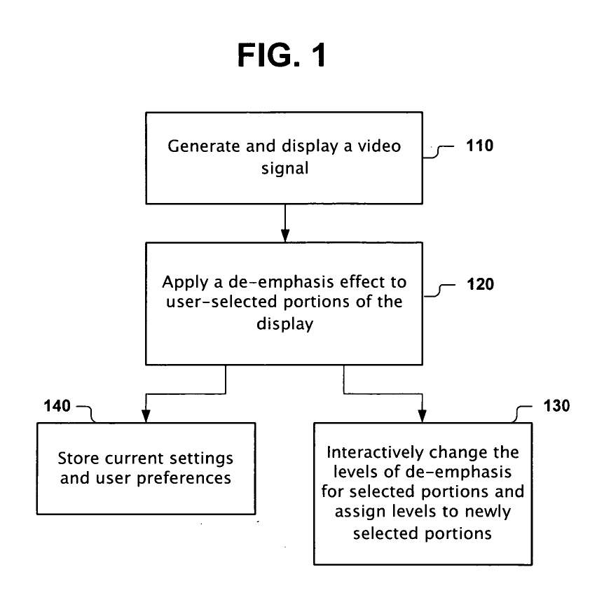

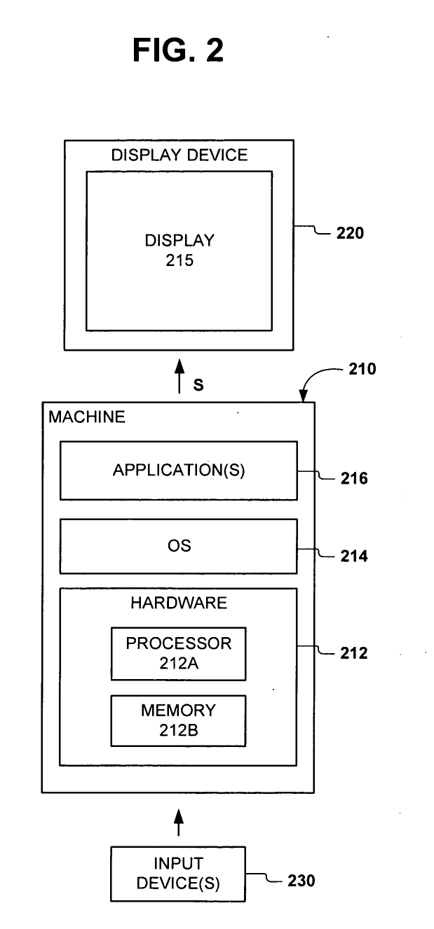

Reference is made to FIGS. 1 and 2. A machine (e.g., computer, medical monitoring station, PDA, cellular telephone, digital audio player) 210 includes hardware 212 (e.g., a processing unit 212a, memory 212b), and an operating system 214 running on top of the hardware 212. One or more applications 216 may run on top of the operating system 214. The machine 210 generates a video display signal (S) and sends the video signal (S) to a display device 220 such as a CRT monitor or flat panel monitor.

The display device 220 displays the video signal (block 110). The displayed signal will be referred to as a “display” 215. The display 215 may include background and foreground elements such as icons, windows and menus. For example, the display may be of a graphical user interface (GUI) desktop” generated by a machine 210 running a “WINDOWS”® or Linux operating system. The display 215 may include standard desktop elements such as a background (e.g., wallpaper), and foreground elements (e.g., icons, thumbnails, toolbars). Applications 216 such as web browsers, instant messengers and teleconferencing programs may run on the operating system 216. For each of these applications 216, one or more windows may appear in the display 215.

The machine 210 can be used, and the display 215 can be viewed, by one or more people. By way of example, FIGS. 1 and 2 will be described in connection with a single person (a “user”).

The user causes the machine 210 to apply a de-emphasis effect to de-emphasize user-selected portions of the video display 215 to reduce visual distraction caused by those portions (block 120). In some embodiments, when the de-emphasis effect is applied, portions of interest are displayed in-focus and portions of lesser interest are displayed out-of-focus (i.e., blurred).

A selected portion is not limited to any particular part of the display 215. A selected portion may include a single element in the display 215, a group of elements (same or different) in the display 215, the background only, a portion of the background along with foreground objects, etc. More than one portion may be selected by the user.

Portions may be pre-designated. For instance, a display 215 may be divided into four pre-designated quadrants. Selecting a quadrant and assigning a de-emphasis level causes everything within the selected quadrant to be displayed at the assigned level.

The levels of de-emphasis are discrete. For example, if only two levels of de-emphasis are assigned by the user, portions assigned a first level may be emphasized (e.g., in-focus), and portions assigned a second level may be de-emphasized (e.g., blurred).

Additional levels of de-emphasis could be assigned by the user. For example, portions assigned a third level are blurrier than portions assigned the second level, portions assigned a fourth level are blurrier than the portions assigned the third level, and so on. When multiple levels can be assigned, different portions may be grouped together and assigned the same level. The wall paper or other graphics on the desktop might be set to be extremely blurred, while other portions are less blurred or in-focus.

Text within a selected portion could be blurred while the remainder of the selected portion is in focus. Text in a de-emphasized window could be visible but not readable and therefore less visually demanding than readable text.

The user may use an input source 230 to interactively select the portions and assign the de-emphasis levels to the selected portions. User input sources 230 may include, without limitation, keyboards, pointing devices, microphones, pressure-sensitive devices, and cameras. Additional sources of input may be accessed via wired or wireless connections (e.g., medical monitoring sensors, digital cameras).

The user may use a pointing device 230 such as a mouse. For example, the user might use the mouse to right-click the side frame of a window to bring it out-of-focus or back into focus. A wheel on the mouse might be used to enlarge or shrink an area of focus.

If the machine 210 has a keyboard, the user may use keystrokes to select portions, or tab between elements. For example, Control+Alt+right-click on the background or “desktop” could toggle the de-emphasis functionality on and off. Using both mouse and keyboard, control+right-click might be used to focus several windows at once.

If the display device 220 has a touch screen, the touch screen could be used to select portions and assign the depth level. If the machine 210 has a microphone, voice commands could be used to select portions and assign levels. If the machine 210 has an input device that tracks head motion (e.g., a paraplegic interface that uses head pressure to contact points), the user could select portions of the display 215 based on head motion and pressure.

If the machine 210 has multiple video capture devices (e.g., web cameras) for capturing video of the user's eyes or face, and if the machine 210 has appropriate software, it can triangulate on the user's eyes to determine the direction of the user's gaze. The machine 210 could then select portions of the display 215 by automatically tracking the eyes/facial movement in the captured video. For example, those portions where the user is looking could be made in-focus, and the remaining portions of the display 215 could be made out-of-focus. The machine 210 need only be accurate enough to recognize which window(s) the user was focusing on.

The user may interactively set conditions upon which a selected portion goes from one de-emphasis level to another. A window may go from out-of-focus to in-focus according to activity in the window. A user might use the different levels for monitoring a scene, without needing detail until motion or another event occurs. Consider a window for e-mail. The window may be blurred while inactive, but changes to in-focus when an e-mail message is received. Consider a pop-up window for instant messaging. The pop-up window may be blurred when it “pops up” so that it is easy for the user to ignore, but may be brought into focus if the user chooses to hover the mouse-cursor over it. Or consider a window for teleconferencing. The window may be blurred while a conference room is empty, but is then displayed in-focus when an event occurs (e.g., people entering the room, sounds being generated from within the room).

The task of de-emphasizing (e.g., blurring) selected portions may be handled by the operating system 214, an application 216, or both. If a selected portion is de-emphasized by blurring, a selected portion may be blurred by a technique such as shifting and overlaying on the same area; or “bleeding” of the pixels to the surrounding pixels; or reducing the resolution and re-sizing back to the original size. Where a portion is blurred by shifting and overlaying the portion on the same area, the amount of shifting may be varied to obtain the assigned level of blur.

The user may interactively change the levels of de-emphasis (block 130). The user may interactively select other portions, bring unfocused portions into focus, etc (block 130).

The user may store current settings in memory 212b for later use, and set user preferences interactively or non-interactively (block 140). Storing the current settings (e.g., selected objects, conditions) allows the machine 210 to display the previously-selected portions at their assigned de-emphasis levels.

The user preferences may specify the preferred means of selecting and de-selecting portions of the display 215; preferred means for assigning de-emphasis levels, how the blurring is performed; degree of blurring for each level; whether blurred portions have sharp edges or fuzzy edges; sensitivity of the tracking of the eyes and/or the face movement (if such tracking is available); and how fast an area blurs after being selected.

The user preferences may specify pre-designated portions (e.g. quadrants) of the display, and specific groups of elements, and it may specify default levels of de-emphasis. The user preferences may specify keystrokes for selecting these pre-designated portions. The user preference may set default de-emphasis levels for elements generated by specific programs.

The user preferences may specify default conditions. For instance, the user preferences may specify that an active window is always in focus unless specifically de-selected.

The user preferences may include a preferred contact list, allowing incoming messages to be checked against the list and only messages from the contacts on the list cause the message window to come into focus.

Thus disclosed are a method and system that are user-initiated and user-controlled. A user is allowed to control how “eye-grabbing” each of potentially many disparate sets of simultaneously-displayed visual information and signals should be.

A method and system according to the present invention can reduce visual distractions in displays that include only a few foreground elements. However, the method and system are especially useful for displays large enough to show many windows at once, and computers fast and powerful enough to handle multiple applications at once. For example, it can reduce the distraction caused by multiple pop-up windows for real-time communications applications between networked computers (instant messenger, voice, etc.). Applying the de-emphasis effect can reduce distractions caused by words or images that would otherwise needlessly catch the user's eye. Because the blurred portions are less demanding on the eyes, the user's fatigue and eye strain can be reduced. Because distractions are less likely to occur, the likelihood of errors is reduced.

A method and system according to the present invention are not limited to reducing visual distractions. Selected portions can be de-emphasized for other reasons. For instance, a portion could be de-emphasized for security or privacy reasons. Confidential or private information could be blurred to make it difficult for an onlooker to read.

The de-emphasis effect can be used in combination with another technique such as dimming. For example, the operating system 214 or an application 216 might automatically reduce the brightness or contrast (that is, dim) a window that is inactive. A user could apply an additional de-emphasis effect to dimmed windows to make them less distracting.

A method and system according to the present invention is not limited to blurring as a way of de-emphasizing portions of a display. In some embodiments, dimming or color-coding may be used to de-emphasize selected portions of a display to reduce visual distractions caused by those portions. In these embodiments, a user would select portions, which would go dim or change colors to something that doesn't catch the user's eye. In these embodiments, a machine (through its operating system, for example) could also perform dimming and color coding in the conventional manner.

A method and system according to the present invention is not limited to any particular setting. For example, it could be used in a home or office setting.

A method and system according to the present invention could be used in a hospital setting. Different levels of blurring could be assigned to inactive readouts for monitors at patient bedsides, central nursing stations (e.g., for critical care unit/intensive care unit/labor and delivery) and other locations where medical monitoring is performed. For instance, if a patient is not in a room, then the displayed information for that room could be blurred on the central monitoring station display. Or during bedside monitoring of a single patient, if respiration and pulse are being monitored but EKG leads have been disconnected, the readouts for respiration and pulse could be displayed in focus and the readout section for the disconnected EKG leads could be blurred, making it easier for medical personnel to identify the active information at a glance.

Staff may need to open and refer to a history or other informational window for in-depth data while peripherally continuing to “keep an eye” on current readouts (not following every detail but keeping them visible in case they send visual alarm signals such as blinking, changing color) When discussing a patient's progress and treatment, medical staff might cause a history/trends window to be fully focused, while slightly blurring current readouts of active monitoring sensors to de-emphasize them. However, the blurred windows would still be readable and visible in case they started to blink or change color to indicate problems. Readouts for idle sensors (e.g., sensors not currently hooked up to the patient) would be more blurred.

Different computer applications could take advantage of the different levels of de-emphasis. For example, multiple windows could be kept in focus (and everything else blurred) to facilitate cutting and pasting between them, even if the two windows correspond to separate applications. Motion and direction of the user's eyes can be analyzed for patterns such as repeatedly moving back and forth between two areas. Users who often compare two documents or cut-and-paste between documents may choose to allow several windows to be kept in focus. The system can detect that the user is frequently moving between them, and make the shift between windows easier.

Although specific embodiments of the present invention have been described and illustrated, the present invention is not limited to the specific forms or arrangements of parts so described and illustrated. Instead, the present invention is construed according to the following claims.

1. A method of using a machine to view a video display, the method comprising interactively causing the machine to apply a de-emphasis effect to visually de-emphasize user-selected portions of the video display.

2. The method of claim 1, wherein level of de-emphasis is interactively user-assigned.

3. The method of claim 2, wherein the levels are discrete and include a first level for in-focus portions, and a second level for out-of-focus portions.

4. The method of claim 3, wherein more than two levels are assigned.

5. The method of claim 1, further comprising assigning conditions to the selected portions with respect to assigned levels

6. The method of claim 5, wherein the a selected portion is emphasized according to activity in the portion.

7. The method of claim 1, wherein the selected-portions can be re-emphasized at a later time.

8. The method of claim 1, wherein the portions are selected by using an input source for the machine.

9. The method of claim 1, wherein a portion is selected by detecting and responding to a user's eyes or facial orientation.

10. The method of claim 1, wherein de-emphasis effect preferences are user controlled.

11. The method of claim 1, wherein text in selected portions is out-of-focus.

12. The method of claim 1, wherein the de-emphasis effect is applied by an application running in the machine.

13. The method of claim 1, wherein the de-emphasis effect is applied by an operating system running in the machine.

14. A method of generating a display for viewing by a user, the method comprising complying with a user-initiated request to apply a de-emphasis effect to portions of the display outside of a user-selected portion to reduce visual distraction caused by those outside portions.

15. The method of claim 14, further comprising displaying a user interface that allows the user to initiate the request and identify the selected portions.

16. A method of using a machine to generate a video signal, the method comprising viewing a display of the signal; and
interactively causing the machine to blur user-selected portions of the display to reduce visual distraction caused by those portions.

17. A machine for supplying a display to a display device, the machine comprising a processor for enabling users to reduce visual distraction by selectively applying an effect to user-selected portions of the display to make those portions less eye catching and less demanding to the users.

18. The machine of claim 17, further comprising a user input source for identifying the user selections and for assigning levels to the user selections; wherein the processor applies the effect in response to the selections at the assigned levels.

19. Apparatus for use with a display device, the apparatus comprising:
means for generating a display signal for the display device; and
a user input source for interactively selecting portions of the displayed signal and for assigning different levels to the selected portions;
wherein the means, in response to the user input source, modifies the display signal by applying a de-emphasis effect to the selected portions at the assigned levels.

20. An article for a processor-based machine, the article comprising memory encoded with code for causing the machine to allow a user to reduce visual distractions by selectively applying a de-emphasis effect to portions of the display to make those portions less eye catching and less demanding to view.
